(19) United States
(12) Patent Application Publication
(10) Pub. No.: US 2023/0403737 A1
(43) Pub. Date: Dec. 14, 2023

(54) CBR Acquisition Through Inter-UE Signaling

(71) Applicant: Fraunhofer-Gesellschaft zur Förderung der angewandten Forschung e.V., Munchen (DE)

(72) Inventors: Dariush MOHAMMAD SOLEYMANI, Erlangen (DE); Martin LEYH, Erlangen (DE); Elke ROTH-MANDUTZ, Erlangen (DE); Shubhangi BHADAURIA, Erlangen (DE); Mehdi HAROUNABADI, Erlangen (DE); Dietmar LIPKA, Erlangen (DE)

(21) Appl. No.: 18/457,551

(22) Filed: Aug. 29, 2023

Related U.S. Application Data
(63) Continuation of application No. PCT/EP2022/055007, filed on Feb. 28, 2022.

(30) Foreign Application Priority Data
Mar. 2, 2021 (EP) 21160266.9

(51) Int. Cl. H04W 74/08; H04W 72/40

(52) U.S. Cl. CPC H04W 74/0808; H04W 72/40; H04W 88/04

(57) ABSTRACT

Disclosed is a first user equipment of a wireless communication system, wherein the first user equipment is configured to operate in a sidelink scenario, in which resources for a sidelink communication over a sidelink channel are allocated or scheduled autonomously by the first user equipment, wherein the first user equipment is configured to receive a channel busy ratio report from a second user equipment of the wireless communication system, the channel busy ratio report describing a channel busy ratio, CBR, of the sidelink channel.

### CROSS-REFERENCE TO RELATED APPLICATIONS

This application is a continuation of copending International Application No. PCT/EP2022/055007, filed Feb. 28, 2022, which is incorporated herein by reference in its entirety, and additionally claims priority from European Application No. 21160266.9, filed Mar. 2, 2021, which is also incorporated herein by reference in its entirety.

### TECHNICAL FIELD

Embodiments of the present application relate to the field of wireless communication, and more specifically, to sharing of channel busy ratio, CBR, between user equipment's, UEs. Some embodiments relate to CBR acquisition through inter-UE signaling.

### BACKGROUND OF THE INVENTION

FIG. 1 is a schematic representation of an example of a terrestrial wireless network 100 including, as is shown in FIG. 1(a), a core network 102 and one or more radio access networks RAN1, RAN2, . . . RANN. FIG. 1(b) is a schematic representation of an example of a radio access network RANn that may include one or more base stations gNB1 to gNB5, each serving a specific area surrounding the base station schematically represented by respective cells 1061 to 1065. The base stations are provided to serve users within a cell. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANn may include more or less such cells, and RANn may also include only one base station. FIG. 1(b) shows two users UE1 and UE2, also referred to as user equipment, UE, that are in cell 1062 and that are served by base station gNB2. Another user UE3 is shown in cell 1064 which is served by base station gNB4. The arrows 1081, 1082 and 1083 schematically represent uplink/downlink connections for transmitting data from a user UE1, UE2 and UE3 to the base stations gNB2, gNB4 or for transmitting data from the base stations gNB2, gNB4 to the users UE1, UE2, UE3. Further, FIG. 1(b) shows two IoT devices 1101 and 1102 in cell 1064, which may be stationary or mobile devices. The IoT device 1101 accesses the wireless communication system via the base station gNB4 to receive and transmit data as schematically represented by arrow 1121. The IoT device 1102 accesses the wireless communication system via the user UE3 as is schematically represented by arrow 1122. The respective base station gNB1 to gNB5 may be connected to the core network 102, e.g., via the S1 interface, via respective backhaul links 1141 to 1145, which are schematically represented in FIG. 1(b) by the arrows pointing to “core”. The core network 102 may be connected to one or more external networks. Further, some or all of the respective base station gNB1 to gNB5 may connected, e.g., via the S1 or X2 interface or the XN interface in NR, with each other via respective backhaul links 1161 to 1165, which are schematically represented in FIG. 1(b) by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix (CP) length. All OFDM symbols may be used for DL or UL or only a subset, e.g., when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1 may by a heterogeneous network having distinct overlaid networks, e.g., a network of macro cells with each macro cell including a macro base station, like base station gNB1 to gNB5, and a network of small cell base stations (not shown in FIG. 1), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the NR (5G), new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex, TDD, systems.

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3 is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the NR mode 1 or LTE mode 3 UEs 202, 204 also NR mode 2 or LTE mode 4 UEs 206, 208, 210 are present.

Naturally, it is also possible that the first vehicle 202 is covered by the gNB, i.e. connected with Uu to the gNB, wherein the second vehicle 204 is not covered by the gNB and only connected via the PC5 interface to the first vehicle 202, or that the second vehicle is connected via the PC5 interface to the first vehicle 202 but via Uu to another gNB, as will become clear from the discussion of FIGS. 4 and 5.

FIG. 4 is a schematic representation of a scenario in which two UEs directly communicating with each, wherein only one of the two UEs is connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204, wherein only the first vehicle 202 is in the coverage area 200 of the base station gNB. Both vehicles 202, 204 are connected directly with each other over the PC5 interface.

FIG. 5 is a schematic representation of a scenario in which two UEs directly communicating with each, wherein the two UEs are connected to different base stations. The first base station gNB1 has a coverage area that is schematically represented by the first circle 2001, wherein the second station gNB2 has a coverage area that is schematically represented by the second circle 2002. The UEs directly communicating with each other include a first vehicle 202 and a second vehicle 204, wherein the first vehicle 202 is in the coverage area 2001 of the first base station gNB1 and connected to the first base station gNB1 via the Uu interface, wherein the second vehicle 204 is in the coverage area 2002 of the second base station gNB2 and connected to the second base station gNB2 via the Uu interface.

In a wireless communication system as described above, such as LTE or New Radio (5G), channel busy ratio, CBR, is one of the important measurements in a UE which might be applied on several control and decision mechanisms such as congestion control, radio resource allocation, relay selection, and etc. However, in power saving UEs where partial sensing and DRX might be applied, the correct measurement of CBR is not possible.

Based on [1], NG-RAN may configure measurement and reporting of CBR for NR sidelink communication and V2X sidelink communication, and reporting of location information for V2X sidelink communication to the UE via RRCReconfiguration. Based on [2], NR Measurement and reporting related to NR sidelink communication is defined to provide some information to assist network's scheduling and/or transmission parameter adjustment, CBR measurement and reporting is performed for the RRC_CONNECTED UEs.

Details of the measurement and reporting mechanism specific for NR sidelink communication are specified in [3, section 17, clause 5.5].

The network may configure the UE to perform the CBR measurements for sidelink [3]. For CBR measurement of NR sidelink communication, a measurement object is a set of transmission resource pool(s) on a single carrier frequency for NR sidelink communication.

For V2X sidelink communication, each of the CBR measurement results is associated with a resource pool, as indicated by the poolReportId [4], that refers to a pool as included in sl-ConfigDedicatedEUTRA-Info or SIB13.

UE can be configured to perform CBR measurement on the transmission resource pools indicated by sl-TxPoolSelectedNormal, sl-TxPoolScheduling or sl-TxPoolExceptional for NR sidelink communication transmission, as specified in [3, 5.5.3].

Further, [3] describes a measurement reporting. The purpose of this procedure is to transfer measurement results from the UE to the network. The UE shall initiate this procedure only after successful AS security activation.

For the measId for which the measurement reporting procedure was triggered, the UE shall set the measResults within the MeasurementReport message as follows:
if there is at least one applicable transmission resource pool for NR sidelink communication (for measResultsSL):
   set the measResultsListSL to include the CBR measurement results in accordance with the following:
      if the reportType is set to event Triggered:
         include the transmission resource pools included in the poolsTriggeredList as defined within the VarMeasReportList for this measId;
      else:
         include the applicable transmission resource pools for which the new measurement results became available since the last periodical reporting or since the measurement was initiated or reset;
      if the corresponding measObject concerns NR sidelink communication, then for each transmission resource pool to be reported:
         set the sl-poolReportIdentity to the identity of this transmission resource pool;
         set the sl-CBR-ResultsNR to the CBR measurement results on PSSCH and PSCCH of this transmission resource pool provided by lower layers, if available.

Based on [5], sidelink, SL, channel busy ratio, CBR, measured in slot n is defined as the portion of sub-channels in the resource pool whose SL RSSI measured by the UE exceed a (pre-)configured threshold sensed over a CBR measurement window [n−a, n−1], wherein a is equal to 100 or 100·2μ slots, according to higher layer parameter timeWindowSize-CBR.

Further, based on [5], sidelink, SL, channel occupancy ratio, CR, evaluated at slot n is defined as the total number of sub-channels used for its transmissions in slots [n−a, n−1] and granted in slots [n, n+b] divided by the total number of configured sub-channels in the transmission pool over [n−a, n+b].

Based on [6], sidelink congestion control in sidelink resource allocation mode 2 can be performed. If a UE is configured with higher layer parameter sl-CR-Limit and transmits PSSCH in slot n, the UE shall ensure the following limits for any priority value k;

Σ_{i≥k}CR(i)≤CR_{Limit}(k)

where CR(i) is the CR evaluated in slot n−N for the PSSCH transmissions with “Priority” field in the SCI set to i, and CR_{Limit}(k) corresponds to the high layer parameter sl-CR-Limit that is associated with the priority value k and the CBR range which includes the CBR measured in slot n−N, where N is the congestion control processing time.

The congestion control processing time N is based on μ of Table 1 and Table 2 for UE processing capability 1 and 2 respectively, where μ corresponds to the subcarrier spacing of the sidelink channel with which the PSSCH is to be transmitted. A UE shall only apply a single processing time capability in sidelink congestion control.

TABLE 1
Congestion control processing time
for processing timing capability 1

| | Congestion control processing time |
|---|---|
| μ | N [slots] |
| 0 | 2 |
| 1 | 2 |
| 2 | 4 |
| 3 | 8 |

TABLE 2
Congestion control processing time
for processing timing capability 2

| | Congestion control processing time |
|---|---|
| μ | N [slots] |
| 0 | 2 |
| 1 | 4 |
| 2 | 8 |
| 3 | 16 |

It is up to UE implementation how to meet the above limits, including dropping the transmissions in slot n.

Thus, starting from the above, there is a need for improvements or enhancements with respect to an availability of CBR information in power saving UEs, such as power saving UEs where partial sensing and/or DRX is applied.

It is noted that the information in the above section is only for enhancing the understanding of the background of the invention and therefore it may contain information that does not form known technology and is already known to a person of ordinary skill in the art.

### SUMMARY

An embodiment may have a first user equipment of a wireless communication system, wherein the first user equipment is configured to operate in a sidelink scenario, in which resources for a sidelink communication over a sidelink channel are allocated or scheduled autonomously by the first user equipment, wherein the first user equipment is configured to receive a channel busy ratio report from a second user equipment of the wireless communication system, the channel busy ratio report describing a channel busy ratio, CBR, of the sidelink channel.

Another embodiment may have a second user equipment of a wireless communication system, wherein the second user equipment is configured to operate in a sidelink scenario, in which resources for a sidelink communication over a sidelink channel are allocated or scheduled autonomously by the second user equipment, wherein the second user equipment is configured to perform a channel busy ratio measurement on the sidelink channel, wherein the second user equipment is configured to transmit, based on the channel busy ratio measurement, a channel busy ratio report to a first user equipment directly via the sidelink.

Another embodiment may have a transceiver of a wireless communication system, wherein the transceiver is configured to receive, from a second user equipment of the wireless communication system a channel busy ratio report describing a channel busy ratio, CBR, of a sidelink channel, wherein the transceiver is configured to transmit, to a first user equipment of the wireless communication system, the channel busy ratio report or a further processed version of the channel busy ratio report.

According to another embodiment, a method for operating a first user equipment of a wireless communication system may have the steps of: operating the first user equipment in a sidelink scenario, in which resources for a sidelink communication over a sidelink channel are allocated or scheduled autonomously by the first user equipment, and receiving a channel busy ratio report from a second user equipment of the wireless communication system, the channel busy ratio report describing a channel busy ratio, CBR, of the sidelink channel.

According to another embodiment, a method for operating a second user equipment of a wireless communication system may have the steps of: operating the second user equipment in a sidelink scenario, in which resources for a sidelink communication over a sidelink channel are allocated or scheduled autonomously by the second user equipment, performing a channel busy ratio measurement on the sidelink channel, and transmitting, based on the channel busy ratio measurement, a channel busy ratio report to a first user equipment directly via the sidelink.

According to another embodiment, a method for operating a transceiver of a wireless communication system may have the steps of: receiving, from a second user equipment of the wireless communication system, a channel busy ratio report describing a channel busy ratio, CBR, of a sidelink channel, and transmitting, to a first user equipment of the wireless communication system, the channel busy ratio report or a further processed version of the channel busy ratio report.

### BRIEF DESCRIPTION OF THE DRAWINGS

Embodiments of the present invention are described herein making reference to the appended drawings, in which:

FIGS. 1(a) and 1(b) show a schematic representation of an example of a wireless communication system;

FIG. 2 is a schematic representation of an in-coverage scenario in which UEs directly communicating with each other are connected to a base station;

FIG. 3 is a schematic representation of an out-of-coverage scenario in which UEs directly communicating with each other receive no SL resource allocation configuration or assistance from a base station;

FIG. 4 is a schematic representation of a partial out-of-coverage scenario in which some of the UEs directly communicating with each other receive no SL resource allocation configuration or assistance from a base station;

FIG. 5 is a schematic representation of an in-coverage scenario in which UEs directly communicating with each other are connected to different base stations;

FIG. 6 is a schematic representation of a wireless communication system comprising a transceiver, like a base station or a relay, and a plurality of communication devices, like UEs;

FIG. 7 is a schematic representation of a wireless communication system comprising a plurality of communication devices, like UEs, directly communicating with each other via the sidelink;

FIG. 8 is a schematic representation of a wireless communication system comprising a base station and a plurality of communication devices, like UEs, communicating with the base station; and

FIG. 9 illustrates an example of a computer system on which units or modules as well as the steps of the methods described in accordance with the inventive approach may execute.

### DETAILED DESCRIPTION OF THE INVENTION

Equal or equivalent elements or elements with equal or equivalent functionality are denoted in the following description by equal or equivalent reference numerals.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

As indicated above, channel busy ratio, CBR, is one of the important measurements in a UE which might be applied on several control and decision mechanisms such as congestion control, radio resource allocation, relay selection, and etc. However, in power saving UEs, where partial sensing and/or DRX might be applied, the correct measurement of CBR is not possible.

In accordance with embodiments, channel busy ratio, CBR, are provided to power-saving UEs through inter-UE signaling, for example, directly via the sidelink and/or via a base station (gNB) or a relay of the wireless communication system.

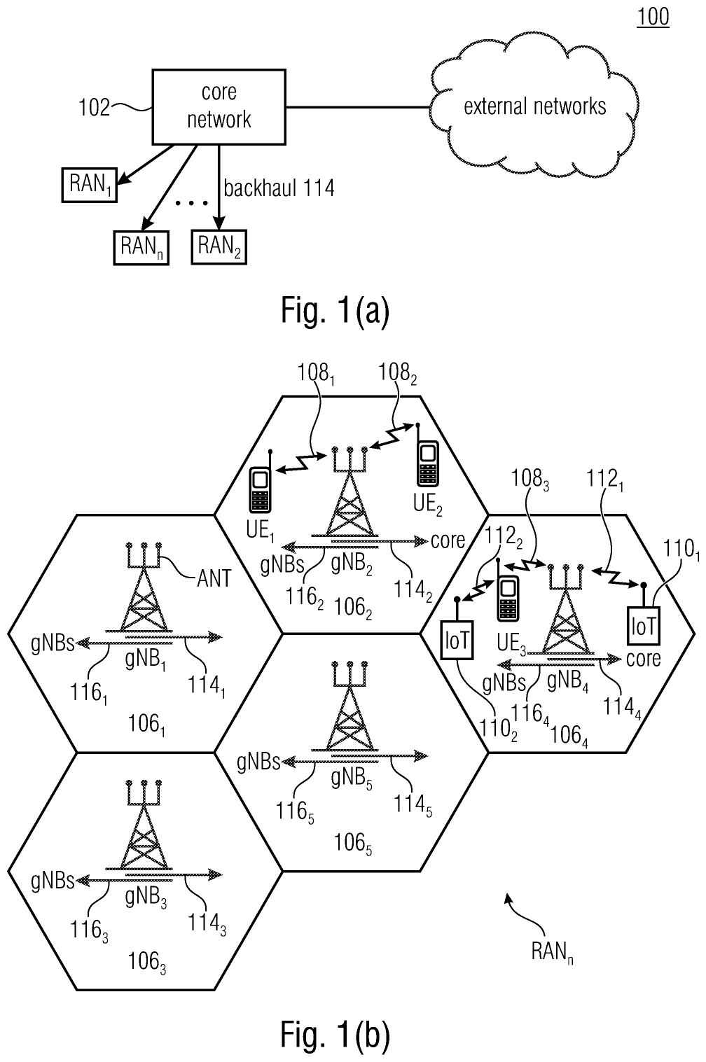

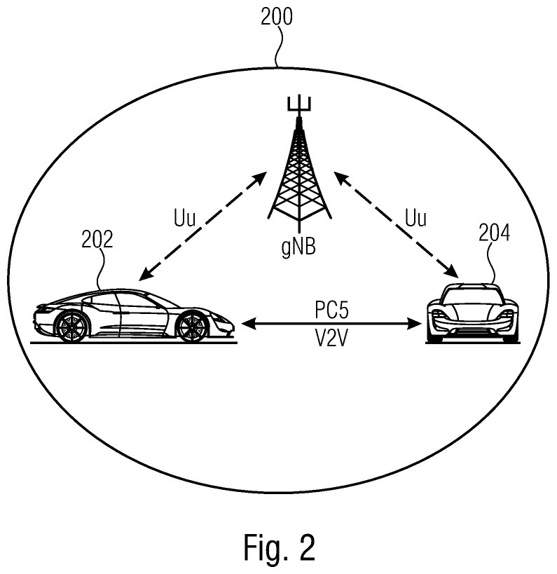

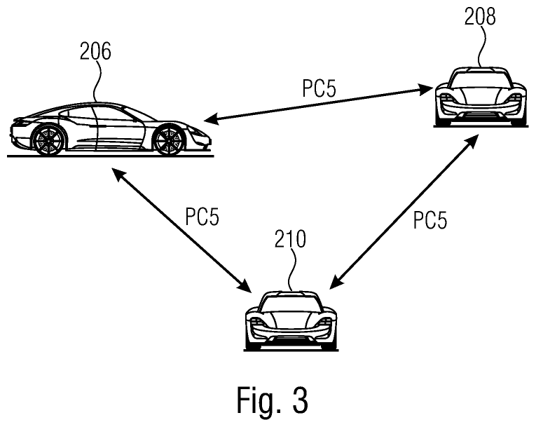

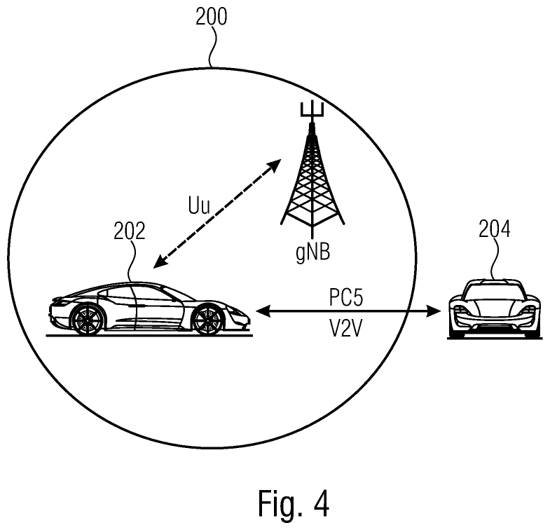

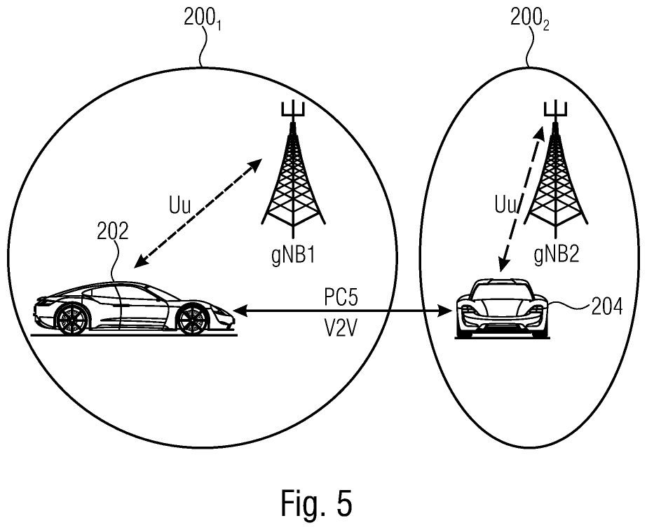

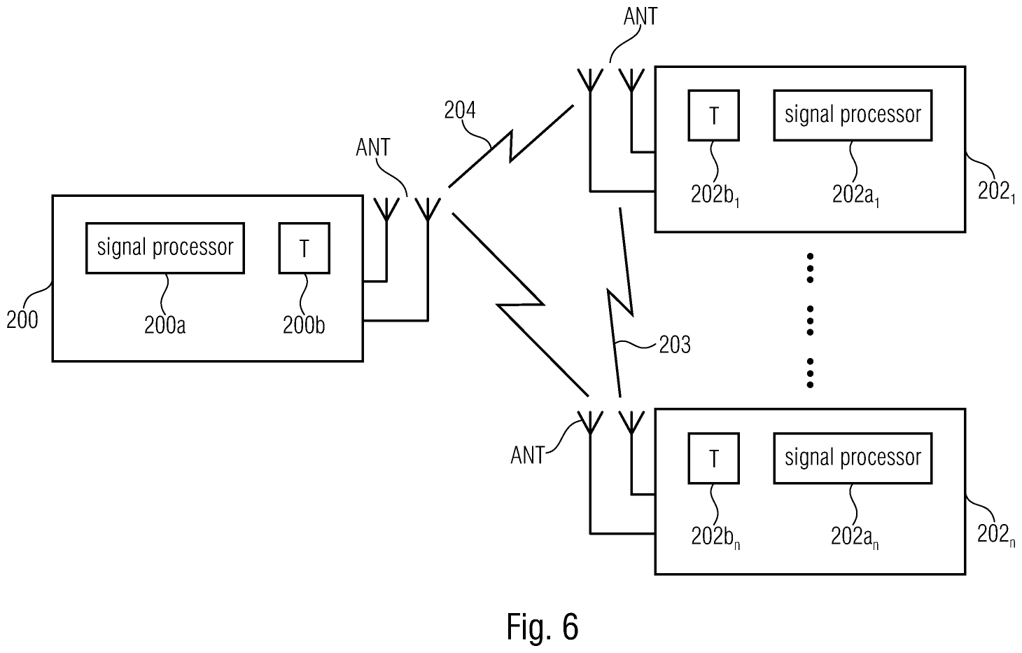

Embodiments of the present invention may be implemented in a wireless communication system or network as depicted in FIGS. 1 to 5 including a transceiver, like a base station, gNB, or relay, and a plurality of communication devices, like user equipment's, UEs. FIG. 6 is a schematic representation of a wireless communication system comprising a transceiver 200, like a base station or a relay, and a plurality of communication devices 202₁ to 202ₙ, like UEs. The UEs might communicated directly with each other via a wireless communication link or channel 203, like a radio link (e.g., using the PC5 interface). Further, the transceiver and the UEs 202 might communicate via a wireless communication link or channel 204, like a radio link (e.g., using the uU interface). The transceiver 200 might include one or more antennas ANT or an antenna array having a plurality of antenna elements, a signal processor 200a and a transceiver unit 200b. The UEs 202 might include one or more antennas ANT or an antenna array having a plurality of antennas, a signal processor 202a1 to 202an, and a transceiver unit 202b1 to 202bn. The base station 200 and/or the one or more UEs 202 may operate in accordance with the inventive teachings described herein.

Embodiments provide a first user equipment of a [e.g., new radio, NR] wireless communication system, wherein the first user equipment is configured to operate in a [e.g., new radio, NR] sidelink scenario [e.g., sidelink in-coverage, out of coverage or partial coverage scenario; e.g., NR sidelink mode 1 or mode 2], in which resources for a sidelink communication [e.g., transmission and/or reception] over a sidelink channel are allocated or scheduled autonomously by the first user equipment, wherein the first user equipment is configured to receive a channel busy ratio report from a second user equipment of the wireless communication system, the channel busy ratio report describing a channel busy ratio, CBR, of the sidelink channel.

In embodiments, the first user equipment is configured to receive the channel busy ratio report from the second user equipment
directly via the sidelink [e.g., through inter UE signaling], or
via a base station [e.g., gNB] or a relay of the wireless communication system.

In embodiments, the first user equipment is configured to operate in a low-power mode of operation in which a channel busy ratio measurement cannot be performed by the first user equipment.

In embodiments, the first user equipment is configured to operate in at least one out of
a discontinuous reception, DRX, mode of operation,
a partial sensing mode of operation,
a half-duplex mode of operation.

In embodiments, the first user equipment is configured to perform at least one out of
a sidelink resource allocation,
a congestion control, and
a relay selection
   based on the received channel busy ratio report.

In embodiments, the channel busy ratio report describes the channel busy ratio, CBR, of the sidelink channel per traffic type [e.g. periodic, apriodic] and/or per resource pool.

In embodiments, the first user equipment is configured to receive the channel busy ratio report from the second user equipment via a broadcast [e.g., downlink control information, DCI, master information block, MIB, or system information block, SIB] from the base station [e.g., gNB] of the wireless communication system.

In embodiments, the first user equipment is configured to receive the channel busy ratio report via the sidelink in one out of
one or several fields or bits of an inter user equipment radio resource control, RRC, message,
one or several fields or bits of a PC5 unicast link establishment message,
one or several fields or bits of a broadcast or multicast [e.g., groupcast] message,
one or several fields or bits of a discovery message,
one or several fields or bits of a first stage sidelink control information, SCI, and/or second stage sidelink control information, SCI,
one or several fields or bits of a message,
one or several fields or bits of a new SCI format.

In embodiments, the first user equipment is configured to receive the channel busy ratio report via a base station [e.g., gNB] or a relay of the wireless communication system in one out of
one or several fields or bits of a downlink control information [e.g., DCI],
one or several fields or bits of a system broadcast [e.g., system information block, SIB].

In embodiments, the first user equipment is configured to receive together with the channel busy ratio report a validity time report describing a validity time of the channel busy ratio, CBR.

In embodiments, the first user equipment is configured to receive together with the channel busy ratio report a position report describing a position in which the channel busy ratio was measured.

Further embodiments provide a second user equipment of a [e.g., new radio, NR] wireless communication system, wherein the second user equipment is configured to operate in a [e.g., new radio, NR] sidelink scenario [e.g., sidelink in-coverage, out of coverage or partial coverage scenario; e.g., NR sidelink mode 1 or mode 2], in which resources for a sidelink communication [e.g., transmission and/or reception] over a sidelink channel are allocated or scheduled autonomously by the second user equipment, wherein the second user equipment is configured to perform a channel busy ratio measurement on the sidelink channel, wherein the second user equipment is configured to transmit, based on the channel busy ratio measurement, a channel busy ratio report to a first user equipment directly via the sidelink [e.g., through inter UE signaling].

In embodiments, the channel busy ratio report describes the channel busy ratio, CBR, of the sidelink channel per traffic type [e.g. periodic, apriodic] and/or per resource pool.

In embodiments, the second user equipment is configured to transmit the channel busy ratio report to the first user equipment periodically.

In embodiments, a frequency of the periodic transmission of the channel busy ratio report depends on at least one out of
a type of the second user equipment [e.g., power-saving UEs might share CBR information less frequent than non-power-saving UEs],
a battery-level of the second user equipment,
channel busy ratio, CBR, variation levels of resources [e.g. when the variation of CBR is higher than a threshold],
a channel busy ratio, CBR, level [e.g., a CBR threshold can be defined. Depending on the threshold definition, e.g., when passing a defined CBR level, CBR measurements are reported],
a priority of traffic [e.g., received from first stage sidelink control information, SCI],
a geographical location of the second user equipment, or a distance between the second user equipment and the first user equipment [e.g. a location close to a junction or a location inside a building],
a geographical zone or area the second user equipment is located, sensor data [e.g. LIDAR, RADAR, Camera] describing dynamics of a network or congestion of a road,
a higher layer configuration or a pre-configuration.

In embodiments, the second user equipment is configured to transmit the channel busy ratio report in response to an event [e.g., event triggered] [e.g., a change of the CBR level exceeds a (e.g., predefined) threshold].

In embodiments, the event is at least one out of
reaching or passing a [e.g., predefined] battery-level,
reaching or passing a [e.g., predefined] channel busy ratio, CBR, variation levels of resources [e.g. when the variation of CBR is higher than a threshold]
reaching or passing a [e.g., predefined] channel busy ratio, CBR, level [e.g., a CBR threshold can be defined. Depending on the threshold definition, e.g., when passing a defined CBR level, CBR measurements are reported],
reaching or passing a priority of traffic [e.g., received from first stage sidelink control information, SCI],
reaching or passing a [e.g., predefined] geographical location, or a [predefined] proximity to the first user equipment [e.g. a location close to a junction or a location inside a building],
reaching or passing a pre-defined geographical zone or area,
sensor data [e.g., LIDAR, RADAR, Camera] describing a dynamic of a network or congestion of a road reaches or passes a [e.g., predefined] threshold,
a higher layer configuration or a pre-configuration.

In embodiments, the second user equipment is configured to transmit the channel busy ratio report via the sidelink in one out of
one or several fields or bits of an inter user equipment radio resource control, RRC, message,
one or several fields or bits of a PC5 unicast link establishment message,
one or several fields or bits of a broadcast or multicast [e.g., groupcast] message,
one or several fields or bits of a discovery message,
one or several fields or bits of a first stage sidelink control information, SCI, and/or second stage sidelink control information, SCI,
one or several fields or bits of a message,
one or several fields or bits of a new SCI format.

In embodiments, the second user equipment is configured to transmit together with the channel busy ratio report a validity time report describing a validity time of the channel busy ratio, CBR.

In embodiments, the second user equipment is configured to determine the validity time in dependence on variations of the measured channel busy ratio, CBR, over time.

In embodiments, the second user equipment is configured to transmit together with the channel busy ratio report a position report describing a position in which the channel busy ratio was measured.

Further embodiments provide a transceiver [e.g., gNB or relay] of a [e.g., new radio, NR] wireless communication system, wherein the transceiver is configured to receive, from a second user equipment of the wireless communication system a channel busy ratio report describing a channel busy ratio, CBR, of a sidelink channel, wherein the transceiver is configured to transmit, to a first user equipment [e.g., that is using said sidelink channel for a sidelink communication] of the wireless communication system, the channel busy ratio report or a further processed version of the channel busy ratio report [e.g. a combined channel busy report [e.g., obtained by combining at least two CBR reports received from two UEs]].

In embodiments, the transceiver [e.g., relaying UE] is further configured to transmit the channel busy ratio report or the further processed version of the channel busy ratio report to a base station of the wireless communication system.

In embodiments, the transceiver [e.g., relaying UE] is configured to transmit the channel busy ratio report or the further processed version of the channel busy ratio report in one out of
one or several fields or bits of an inter user equipment radio resource control, RRC, message,
one or several fields or bits of a PC5 unicast link establishment message,
one or several fields or bits of a broadcast or multicast [e.g., groupcast] message,
one or several fields or bits of a discovery message,
one or several fields or bits of a first stage sidelink control information, SCI, and/or second stage sidelink control information, SCI,
one or several fields or bits of a message.

In embodiments, the transceiver is configured to transmit the channel busy ratio report or the further processed version of the channel busy ratio report in one out of
one or several fields or bits of a downlink control information, DCI,
one or several fields or bits of a system broadcast [e.g., system information block, SIB].

In embodiments, transceiver is a base station of the wireless communication system.

In embodiments, the transceiver is a relay [e.g., relaying UE] of the wireless communication system.

Further embodiments provide a wireless communication system, comprising
a first transceiver according to one of the embodiments described herein, and
a second transceiver according to one of the embodiments described herein.

Further embodiments provide a wireless communication system, comprising
a first transceiver according to one of the embodiments described herein,
a second transceiver according to one of the embodiments described herein,
a transceiver according to one of the embodiments described herein.

Further embodiments provide a method for operating a first user equipment of a wireless communication system. The method comprises a step of operating the first user equipment in a [e.g., new radio, NR] sidelink scenario [e.g., sidelink in-coverage, out of coverage or partial coverage scenario; e.g., NR sidelink mode 1 or mode 2], in which resources for a sidelink communication [e.g., transmission and/or reception] over a sidelink channel are allocated or scheduled autonomously by the first user equipment. Further, the method comprises a step of receiving a channel busy ratio report from a second user equipment of the wireless communication system, the channel busy ratio report describing a channel busy ratio, CBR, of the sidelink channel.

Further embodiments provide a method for operating a second user equipment of a wireless communication system. The method comprises a step of operating the second user equipment in a [e.g., new radio, NR] sidelink scenario [e.g., sidelink in-coverage, out of coverage or partial coverage scenario; e.g., NR sidelink mode 1 or mode 2], in which resources for a sidelink communication [e.g., transmission and/or reception] over a sidelink channel are allocated or scheduled autonomously by the second user equipment. Further, the method comprises a step of performing a channel busy ratio measurement on the sidelink channel. Further, the method comprises a step of transmitting, based on the channel busy ratio measurement, a channel busy ratio report to a first user equipment directly via the sidelink [e.g., through inter UE signaling].

Further embodiments provide a method for operating a transceiver of a wireless communication system. The method comprises a step of receiving, from a second user equipment of the wireless communication system, a channel busy ratio report describing a channel busy ratio, CBR, of a sidelink channel. Further, the method comprises a step of transmitting, to a first user equipment [e.g., that is using said sidelink channel for a sidelink communication] of the wireless communication system, the channel busy ratio report or a further processed version of the channel busy ratio report [e.g. a combined channel busy report [e.g., obtained by combining at least two CBR reports received from two UEs]].

Subsequently, embodiments are described in further detail that provide CBR measurement in power-saving UEs through inter-UE signaling. Further, additional information that can be sent along with CBR and the containers of such information are described.

### Inter-Coordination of UEs by Sharing CBR Measurement Information

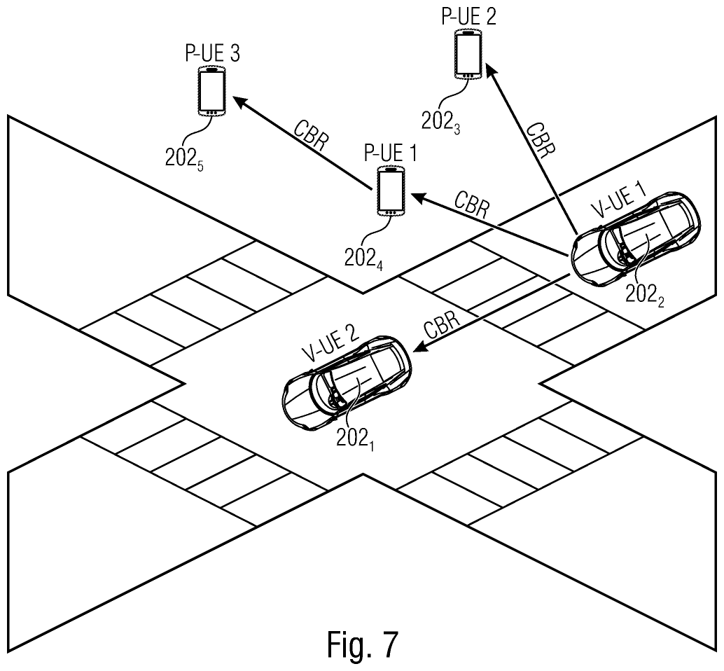

FIG. 7 is a schematic representation of a wireless communication system comprising a plurality of communication devices, like UEs 202₁ to 202₅, directly communicating with each other via the sidelink. Thereby, FIG. 7 shows the case of sharing CBR through inter-UE signaling.

Specifically, as indicated in FIG. 7, a first UE 200₁ (V-UE2) can be configured to receive a channel busy ratio report from a second UE 200₂ (V-UE1) directly via the sidelink (e.g., through inter-UE signaling), the channel busy ratio report describing a channel busy ratio, CBR, of the sidelink channel.

Optional, also a third UE 202₃ (P-UE2) and a fourth UE 200₄ (P-UE1) can be configured to receive the channel busy ratio report from the second UE 200₂ (V-UE1) directly via the sidelink. Thereby, the fourth UE 200₄ (P-UE1) may act as a relay and relay (or transmit) the received channel busy ratio report or a further processed version of the channel busy ratio report to a fifth UE 200₅ (P-UE3).

In embodiments, a UE 202₂ may share its measured CBR with other UEs 202₁, 202₃, 202₄ directly (e.g., through a measurement report on the SL) or with another UE 202₅ indirectly (e.g., through a report to a gNB or through a relay UE.) to assist them, for example, in at least one of the following problems:
resource allocation (e.g., to apply random selection or normal/partial sensing based resource selection),
half-duplex problem where a UE cannot sense while transmission to calculate CBR,
calculation of CBR, to control congestion by controlling Occupancy Ratio (CR) in case of partial sensing, random selection or DRX enabled UEs where CBR cannot be measured correctly,
in relay (re-)selection procedure (e.g., when UEs apply CBR as a relay selection criteria).

In embodiments, the CBR measurements may be added to existing reports or new measurement reports, e.g., as defined in [3] for the Uu or enhanced as defined for PC5, e.g., PC5-RRC or PC5-S (see [7]).

For example, existing measurement reports could be enhanced with CBR and be allowed to be used for relaying (e.g., relay (re-)selection procedure) or enhancing measurement reports on PC5-S or PC5-RRC to consider CBR, and/or preferred/no preferred resources (to be considered by the network or the UE—depending on whether the report is sent via Uu or PC5), e.g., based on CBR measurement performed by the UE or the network on occupied resources in a specific time.

In embodiments, the CBR report between UEs directly or indirectly can be per traffic type (e.g., periodic, apriodic), or per resource pool, or any per any other differentiation.

### Sharing CBR Information Among UEs through gNB

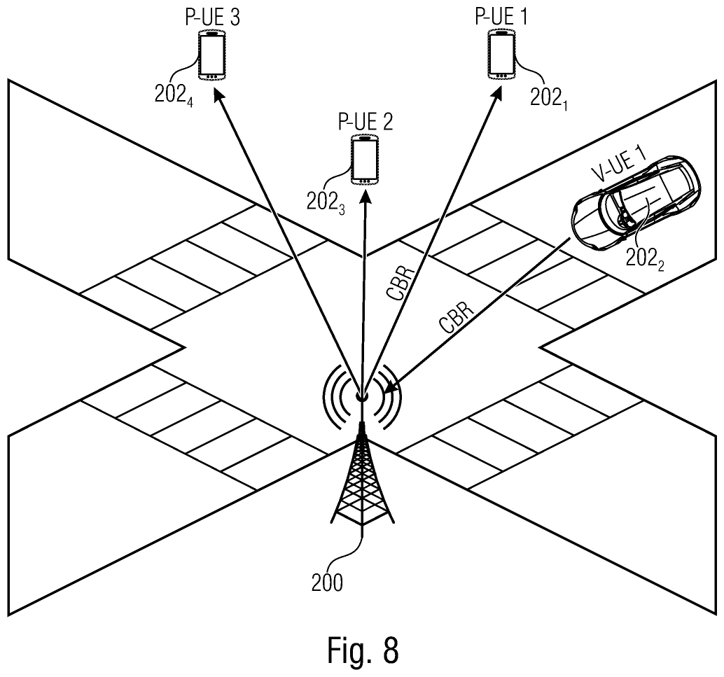

FIG. 8 is a schematic representation of a wireless communication system comprising a base station 200 and a plurality of communication devices, like UEs 202₁ to 202₅, communicating with the base station 200. Thereby, FIG. 8 indicates the case of a CBR report from a gNB to UEs.

Specifically, as indicated in FIG. 8, a first UE 200₁ (P-UE1) can be configured to receive a channel busy ratio report from a second UE 200₂ (V-UE1) via the base station, the channel busy ratio report describing a channel busy ratio, CBR, of the sidelink channel.

Optionally, also a third UE 202₃ (P-UE2) and a fourth UE 200₄ (P-UE3) can be configured to receive the channel busy ratio report from the second UE 200₂ (V-UE1) via the base station.

In other words, in accordance with a general scenario, the gNB 200 might share CBR information, which it has received from UEs 202₁ through CBR report procedure, with UEs 202₁, 202₃ and 202₄ through broadcast (e.g., DCI, MIB, SIB . . . ). This is beneficial especially for type of UEs which do not receive in sidelink and only transmit (e.g., P-UEs).

Alternatively, in a relay scenario, UE which acts a UE-to-network relay, might relay the received CBR information from gNB 200 to a corresponding remote UE. Besides, a relay UE might relay the measured CBR information to the gNB (i.e., relay scenario for CBR sharing with gNB and reception of CBR information from gNB).

### Frequency of CBR Sharing

In embodiments, as the CBR measurement and sharing causes power consumption in UEs and increased spectrum usage, the frequency of CBR sharing with other UEs through inter-UE signaling can be limited, for example, to avoid fast battery drainage in battery-powered UEs and extra spectrum wastage. The sharing of CBR with other UEs by a UE might occur based on at least one of the following options:
1. Periodically.
2. A triggered event (e.g., a considerable change in CBR level).

In case of periodic sharing or CBR information with other UEs, the frequency of CBR sharing can be based on one of the following criteria (examples listed below):
1. The types of a UE (e.g., power-saving UEs might share CBR information less frequent than non-power-saving UEs).
2. The battery-level of a UE.
3. The CBR variation levels of resources (e.g., when the variation of CBR is higher than a threshold).
4. The CBR level, e.g., a CBR threshold can be defined. Depending on the threshold definition, e.g., when passing a defined CBR level, CBR measurements are reported.
5. The priority of traffic (e.g., received from 1st stage SCI).
6. The geographical location or proximity of a UE or UE(s) (e.g., a location close to a junction or a location inside a building).
7. A pre-defined geographical zone (area).
8. An interpretation of sensor data (e.g., LIDAR, RADAR, Camera) about the dynamics of a network or congestion of a road.
9. A higher layer configuration or a pre-configuration.

In case of a trigger event, the CBR sharing could be initiated based on one of the following events (examples):
1. The battery-level of a UE (e.g., reaches, passes or falls below a (pre-defined) threshold).
2. The CBR variation levels of resources (e.g., reaches, passes or falls below a (pre-defined) threshold).
3. The CBR level (e.g., reaches, passes or falls below a (pre-defined) threshold), for example, a CBR threshold can be defined. Depending on the threshold definition, e.g., when passing a defined CBR level, CBR measurements are reported.
4. The priority of traffic (e.g., received from 1st stage SCI) (e.g., reaches, passes or falls below a (pre-defined) threshold).
5. The geographical location or proximity of a UE or UE(s) (e.g., a location close to a junction or a location inside a building) (e.g., a UE reaches or is located within a (pre-defined or specific) geographical location or reaches or is located within a (pre-defined) proximity to one or more other UEs).
6. A pre-defined geographical zone (area) (e.g., a UE reaches or is located within a pre-defined geographical zone or area).
7. An interpretation of sensor data (e.g., LIDAR, RADAR, Camera) about the dynamics of a network or congestion of a road (e.g., fulfills a (predefined) criterion; or reaches, passes or falls below a (predefined) threshold).
8. A higher layer configuration or a pre-configuration.

### Container of CBR Information

The exchange of CBR information among UEs can be done through at least one of the following options for an inter-UE signaling:
1. One or several fields/bits of a UE to UE RRC message.
2. One or several fields/bits of a PC5 unicast link establishment message.
3. One or several fields/bits of a broadcast/multicast (e.g., groupcast) message.
4. One or several fields/bits of a discovery message.
5. One or several fields/bits of existing 1^{st} stage SCI or/and 2^{nd} stage SCI formats (e.g., added field in the 1^{st} stage SCI as follows:
   Priority—3 bits.
   Frequency resource assignment—n bits, wherein n depends on the configuration of higher layers and the number of sub-channels in the resource pool.
   Time resource assignment—5, 9 bits depending on the configuration of higher layers.
   Resource reservation period—n or 0 bit depending on the configurations of higher layers.
   DMRS pattern—x bit if more than one pattern is configured by higher layers, otherwise 0 bit.
   2nd-stage SCI forma—n bits.
   Beta_offset indicator—[2] bits as provided by higher layer parameter sl-BetaOffsets2ndSCI.
   Number of DMRS port—1 bit.
   Modulation and coding scheme—5 bits.
   Reserved—[2-4] bits.
   CBR report, or level—[n] bits.
Or, e.g., added field in the 2^{nd} stage SCI (e.g., format 0-2) as follows:
   HARQ Process ID—n bits.
   New data indicator—1 bit.
   Redundancy version—2 bits.
   Source ID—8 bits.
   Destination ID—16 bits.
   CSI request—1 bit.
   CBR report, or level—[n] bits.)
6. One or several fields/bits of a new 1^{st} stage or/and 2^{nd} stage SCI format.
7. One or several fields/bits of a new type of message.

In case where a CBR information is provided by a gNB, the container might be at least one of the following options:
1. One or several fields/bits of existing DCI format.
2. One or several fields/bits of a new DCI format.
3. One or several fields/bits of any system broadcast (e.g., System Information Block, SIB).

In the following example, modifications (e.g., in the Layer 2) are described for implementing the channel busy ratio report in accordance with embodiments. Thereby, in the below example, elements being underlined and/or printed in bold may be provided, modified or changed according to the inventive approach described herein.

-- ASN1START
-- TAG-MEASUREMENTREPORTSIDELINK-START

| | |
|---|---|
| MeasurementReportSidelink ::= | SEQUENCE { |

| | |
|---|---|
| criticalExtensions | CHOICE { |

```
    measurementReportSidelink-r16
MeasurementReportSidelink-IEs-r16,
    criticalExtensionsFuture
SEQUENCE { }
  }
}
```

| | |
|---|---|
| MeasurementReportSidelink-IEs-r16 ::= | SEQUENCE { |

| | |
|---|---|
| sl-measResults-r16 | SL- |

MeasResults-r16,

| | |
|---|---|
| lateNonCriticalExtension | OCTET |

| | |
|---|---|
| STRING | OPTIONAL, |

| | |
|---|---|
| nonCriticalExtension | SEQUENCE { } |

OPTIONAL
}

| | |
|---|---|
| SL-MeasResults-r16 ::= | SEQUENCE { |

| | |
|---|---|
| sl-MeasId-r16 | SL-MeasId- |

r16,

| | |
|---|---|
| sl-MeasResult-r16 | SL- |

MeasResult-r16,
...
}

| | |
|---|---|
| SL-MeasResult-r16 ::= | SEQUENCE { |

| | |
|---|---|
| sl-ResultDMRS-r16 | SL- |

| | |
|---|---|
| MeasQuantityResult-r16 | OPTIONAL, |

...
}

| | |
|---|---|
| SL-MeasQuantityResult-r16 ::= | SEQUENCE { |

| | |
|---|---|
| s1-RSRP-r16 | RSRP-Range |

OPTIONAL,
...
}
SL-CBRMeasurement-r1* ::= SEQUENCE {*(TBD)}

OPTIONAL,
...}

-- TAG-MEASUREMENTREPORTSIDELINK-STOP
-- ASN1STOP

### Channel Occupancy Ratio (CR) Control by UEs Through Reception of Shared Information About CBR

In embodiments, a UE with a random resource allocation or normal/partial sensing or enabled DRX might control the congestion through the reception of shared CBR information from nearby UEs or from gNB/RSU. In embodiments, a UE might trigger other UEs in the proximity to send their measured CBR.

### Sharing Validity Time and Position of CBR Measurement

In embodiments, as the validity of a CBR measurement depends on the time and the location of measurement, the validity time, or the time of measurement, and the geographical location of measurement might be sent along with the CBR information from a UE which measures the CBR to another UE or set of UEs. In case where a gNB shares CBR information with UEs through broadcast, the validity time, location and time of measurement might be sent from the gNB to a set of UEs.

### Definition of a Validity Timer for a CBR Measurement

In embodiments, the validity time of a CBR measurement might be defined based on the variations in the measured CBR. In case of (semi-)static channel status (w.r.t. the CBR), a UE which measures and shares CBR information with other UE(s), might assign a longer validity time to the CBR measurement. On the other hand, in a channel with high variations of CBR, a UE might assign a shorter validity time.

### Adaptation of DRX, and Partial Sensing Based on the CBR Measurement

In embodiments, a UE might adapt its DRX configuration, or partial sensing configuration based on its measured CBR, or received CBR report from other UEs, or from a gNB, or from a relay UE. A gNB might also adapt the configuration of DRX in UEs based on the received CBR reports from UEs, and configure the UEs with a new configuration. The adaptation of DRX and partial sensing can be based on the CBR level in a resource pool, or based on the CBR of a traffic type.

### Further Embodiments

Channel busy ratio, CBR, is one of the important measurements in a UE which might be applied on several control and decision mechanisms such as congestion control, radio resource allocation, relay selection, and etc. In power saving UEs where partial sensing and/or DRX might be applied, the correct measurement of CBR is not possible. Embodiments air to provide CBR measurement in power-saving UEs through inter-UE signaling. Embodiments also define additional information which is needed to be sent along with CBR and the containers of such information.

CBR sharing as described herein in accordance with embodiments through the inter-UE signaling has several benefits, such as power-saving in UEs, congestion control, and etc. Since the CBR can be applied in several decision making and control mechanism, the sharing of CBR on the SL might be entailed.

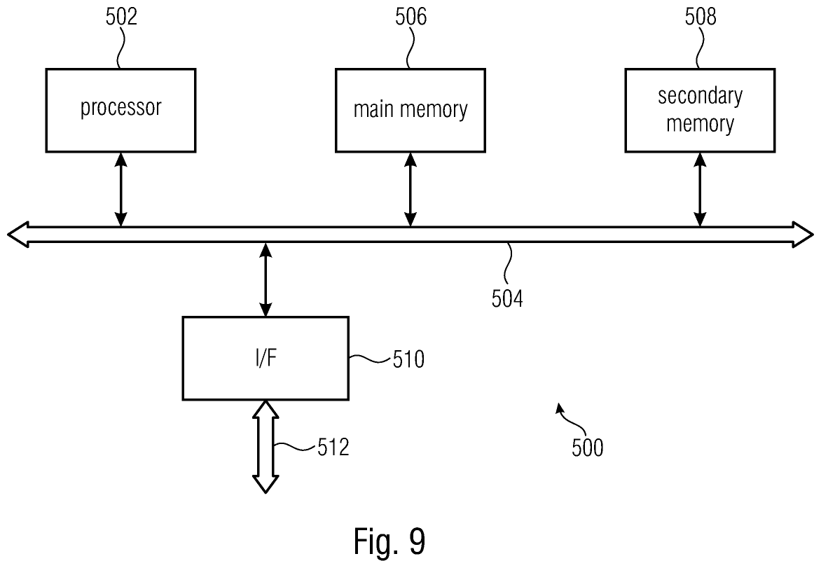

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 9 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the from electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which will be apparent to others skilled in the art and which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### LIST OF REFERENCES

[1] TS 38.300
[2] TS 37.985
[3] TS38.331: Technical Specification Group Radio Access Network; NR; Radio Resource Control (RRC) protocol specification; V16.3.1 (2021-01)
[4] TS 36.331
[5] TS 38.215
[6] TS 38.214
[7] TS 23.287 Technical Specification Group Services and System Aspects; Architecture enhancements for 5G System (5GS) to support; Vehicle-to-Everything (V2X) services; V16.5.0 (2020-12)

### LIST OF ABBREVIATIONS

3GPP third generation partnership project
AIM assistance information message
AL alert limit
AMF access and mobility management function
ARAIM advanced receiver autonomous integrity monitoring
BS base station
BWP bandwidth part
CA carrier aggregation
CC component carrier
CBG code block group
CBR channel busy ratio
D2D device-to-device
DAI downlink assignment index
DCI downlink control information
DL downlink
FFT fast Fourier transform
GMLC gateway mobile location center
gNB evolved node B (NR base station)/next generation node B base station
GNSS global navigation satellite system
HAL horizontal alert limit
HARQ hybrid automatic repeat request
IoT Internet of things
LCS location services
LMF location management function
LPP LTE positioning protocol
LTE long-term evolution
MAC medium access control
MCR minimum communication range
MCS modulation and coding scheme
MIB master information block
MO-LR mobile originated location request
MT-LR mobile terminated location request
NB node B
NI-LR network induced location request
NR new radio
NRPPa NR positioning protocol-annex
NTN non-terrestrial network
NW network
OFDM orthogonal frequency-division multiplexing
OFDMA orthogonal frequency-division multiple access
PBCH physical broadcast channel
PC5 interface using the sidelink channel for D2D communication
PDCCH physical downlink control channel
PDSCH physical downlink shared channel
PL protection level
PLMN public land mobile network
PPP point-to-point protocol
PPP precise point positioning
PRACH physical random access channel
PRB physical resource block
PRS public regulated services (Galileo)
PSCCH physical sidelink control channel
PSSCH physical sidelink shared channel
PUCCH physical uplink control channel
PUSCH physical uplink shared channel
PVT position and/or velocity and/or time
PVT position, velocity and time
RAIM receiver autonomous integrity monitoring
RAN radio access networks
RAT radio access technology
RB resource block
RNTI radio network temporary identifier
RP resource pool
RRC radio resource control
RS reference symbols/signal
RTK real time kinematics
RTT round trip time
SBAS space-based augmentation systems
SBI service based interface
SCI sidelink control information
SI system information
SIB sidelink information block
SL sidelink
SSR state space representation
sTTI short transmission time interval
TDD time division duplex
TDOA time difference of arrival
TIR target integrity risk
TRP transmission reception point
TTA time-to-alert
TTI transmission time interval
UAV unmanned aerial vehicle
UCI uplink control information
UE user equipment
UL uplink
UMTS universal mobile telecommunication system
V2x vehicle-to-everything
V2V vehicle-to-vehicle
V2I vehicle-to-infrastructure
V2P vehicle-to-pedestrian
V2N vehicle-to-network
P-UE pedestrian UE
V-UE vulnerable UE

1. A first user equipment of a wireless communication system,
wherein the first user equipment is configured to operate in a sidelink scenario, in which resources for a sidelink communication over a sidelink channel are allocated or scheduled autonomously by the first user equipment,
wherein the first user equipment is configured to receive a channel busy ratio report from a second user equipment of the wireless communication system, the channel busy ratio report describing a channel busy ratio, CBR, of the sidelink channel.

2. The first user equipment according to claim 1,
wherein the first user equipment is configured to receive the channel busy ratio report from the second user equipment
directly via the sidelink, or
via a base station or a relay of the wireless communication system.

3. The first user equipment according to claim 1,
wherein the first user equipment is configured to operate in a low-power mode of operation in which a channel busy ratio measurement cannot be performed by the first user equipment,
and/or wherein the first user equipment is configured to operate in at least one out of
a discontinuous reception, DRX, mode of operation,
a partial sensing mode of operation,
a half-duplex mode of operation.

4. The first user equipment according to claim 1,
wherein the first user equipment is configured to perform at least one out of
a sidelink resource allocation,
a congestion control,
a relay selection
based on the received channel busy ratio report,
and/or wherein the channel busy ratio report describes the channel busy ratio, CBR, of the sidelink channel per traffic type and/or per resource pool.

5. The first user equipment according to claim 1,
wherein the first user equipment is configured to receive the channel busy ratio report via the sidelink in one out of
one or several fields or bits of an inter user equipment radio resource control, RRC, message,
one or several fields or bits of a PC5 unicast link establishment message,
one or several fields or bits of a broadcast or multicast message,
one or several fields or bits of a discovery message,
one or several fields or bits of a first stage sidelink control information, SCI, and/or second stage sidelink control information, SCI,
one or several fields or bits of a message,
one or several fields or bits of a new SCI format,
or wherein the first user equipment is configured to receive the channel busy ratio report via a base station or a relay of the wireless communication system in one out of
one or several fields or bits of a downlink control information,
one or several fields or bits of a system broadcast.

6. The first user equipment according to claim 1,
wherein the first user equipment is configured to receive together with the channel busy ratio report a validity time report describing a validity time of the channel busy ratio, CBR,
and/or wherein the first user equipment is configured to receive together with the channel busy ratio report a position report describing a position in which the channel busy ratio was measured.

7. A second user equipment of a wireless communication system,
wherein the second user equipment is configured to operate in a sidelink scenario, in which resources for a sidelink communication over a sidelink channel are allocated or scheduled autonomously by the second user equipment,
wherein the second user equipment is configured to perform a channel busy ratio measurement on the sidelink channel,
wherein the second user equipment is configured to transmit, based on the channel busy ratio measurement, a channel busy ratio report to a first user equipment directly via the sidelink.

8. The second user equipment according to claim 7,
wherein the channel busy ratio report describes the channel busy ratio, CBR, of the sidelink channel per traffic type and/or per resource pool.

9. The second user equipment according to claim 7,
wherein the second user equipment is configured to transmit the channel busy ratio report to the first user equipment periodically,
or wherein the second user equipment is configured to transmit the channel busy ratio report in response to an event.

10. The second user equipment according to claim 9,
wherein a frequency of the periodic transmission of the channel busy ratio report depends on at least one out of
a type of the second user equipment,
a battery-level of the second user equipment,
channel busy ratio, CBR, variation levels of resources,
a channel busy ratio, CBR, level,
a priority of traffic,
a geographical location of the second user equipment, or a distance between the second user equipment and the first user equipment,
a geographical zone or area the second user equipment is located,
sensor data describing dynamics of a network or congestion of a road,
a higher layer configuration or a pre-configuration.

11. The second user equipment according to claim 9,
wherein the event is at least one out of
reaching or passing a battery-level,
reaching or passing a channel busy ratio, CBR, variation levels of resources,
reaching or passing a channel busy ratio, CBR, level,
reaching or passing a priority of traffic,
reaching or passing a geographical location or a proximity to the first user equipment,
reaching or passing a pre-defined geographical zone or area,
sensor data describing a dynamic of a network or congestion of a road reaches or passes a threshold,
a higher layer configuration or a pre-configuration.

12. The second user equipment according to claim 7,
wherein the second user equipment is configured to transmit the channel busy ratio report via the sidelink in one out of
one or several fields or bits of an inter user equipment radio resource control, RRC, message,
one or several fields or bits of a PC5 unicast link establishment message,
one or several fields or bits of a broadcast or multicast message,
one or several fields or bits of a discovery message,
one or several fields or bits of a first stage sidelink control information, SCI, and/or second stage sidelink control information, SCI,
one or several fields or bits of a message.
one or several fields or bits of a new SCI format.

13. The second user equipment according to claim 7,
wherein the second user equipment is configured to transmit together with the channel busy ratio report a validity time report describing a validity time of the channel busy ratio, CBR,
and/or wherein the second user equipment is configured to transmit together with the channel busy ratio report a position report describing a position in which the channel busy ratio was measured.

14. A transceiver of a wireless communication system,
wherein the transceiver is configured to receive, from a second user equipment of the wireless communication system a channel busy ratio report describing a channel busy ratio, CBR, of a sidelink channel,
wherein the transceiver is configured to transmit, to a first user equipment of the wireless communication system, the channel busy ratio report or a further processed version of the channel busy ratio report.

15. The transceiver according to claim 14,
wherein the transceiver is further configured to transmit the channel busy ratio report or the further processed version of the channel busy ratio report to a base station of the wireless communication system.

16. The transceiver according to claim 14,
wherein the transceiver is configured to transmit the channel busy ratio report or the further processed version of the channel busy ratio report in one out of
one or several fields or bits of an inter user equipment radio resource control, RRC, message,
one or several fields or bits of a PC5 unicast link establishment message,
one or several fields or bits of a broadcast or multicast message,
one or several fields or bits of a discovery message,
one or several fields or bits of a first stage sidelink control information, SCI, and/or second stage sidelink control information, SCI,
one or several fields or bits of a message,
or wherein the transceiver is configured to transmit the channel busy ratio report or the further processed version of the channel busy ratio report in one out of
one or several fields or bits of a downlink control information, DCI,
one or several fields or bits of a system broadcast.

17. The transceiver according to claim 14,
wherein transceiver is a base station of the wireless communication system,
or wherein the transceiver is a relay of the wireless communication system.

18. A method for operating a first user equipment of a wireless communication system, the method comprising:
operating the first user equipment in a sidelink scenario, in which resources for a sidelink communication over a sidelink channel are allocated or scheduled autonomously by the first user equipment, and
receiving a channel busy ratio report from a second user equipment of the wireless communication system, the channel busy ratio report describing a channel busy ratio, CBR, of the sidelink channel.

19. A method for operating a second user equipment of a wireless communication system, the method comprising:
operating the second user equipment in a sidelink scenario, in which resources for a sidelink communication over a sidelink channel are allocated or scheduled autonomously by the second user equipment,
performing a channel busy ratio measurement on the sidelink channel, and
transmitting, based on the channel busy ratio measurement, a channel busy ratio report to a first user equipment directly via the sidelink.

20. A method for operating a transceiver of a wireless communication system, the method comprising:
receiving, from a second user equipment of the wireless communication system, a channel busy ratio report describing a channel busy ratio, CBR, of a sidelink channel, and
transmitting, to a first user equipment of the wireless communication system, the channel busy ratio report or a further processed version of the channel busy ratio report.
